(19) United States
(12) Patent Application Publication
(10) Pub. No.: US 2015/0162751 A1
(43) Pub. Date: Jun. 11, 2015

(54) WIRELESS CHARGING OF CLOTHING AND SMART FABRICS

(71) Applicant: DvineWave Inc., San Ramon, CA (US)

(72) Inventors: Michael A. Leabman, San Ramon, CA (US); Gregory Scott Brewer, Livermore, CA (US)

(73) Assignee: DvineWave Inc., San Ramon, CA (US)

(21) Appl. No.: 14/103,528

(22) Filed: Dec. 11, 2013

(51) Int. Cl. H02J 5/00; A41D 13/005; A43B 17/00; H04W 4/00; A41D 1/02; A41B 1/08; H02J 7/02; A41D 1/00; A41D 19/015

(52) U.S. Cl. CPC H02J 5/005; A41D 1/002; A41D 13/0051; A43B 17/003; A41D 19/015; A41D 1/02; A41B 1/08; A41D 13/0053; H02J 7/025; H04W 4/008

(57) ABSTRACT

The present disclosure may provide various electric receiver arrangements included in clothing pieces that require electric current to perform tasks, such as warming, cooling and displaying. Suitable wireless power transmission techniques, like pocket forming, may be used to provide the clothing pieces with wireless power. In some embodiments, receivers may include at least one antenna connected to at least one rectifier and one power converter. In other embodiments, receivers including a plurality of antennas, a plurality of rectifiers or a plurality of power converters may be provided. In addition, receivers may include communications components which may allow for communication to various electronic equipment including transmitters.

### CROSS-REFERENCES TO RELATED APPLICATIONS

The present disclosure relates to U.S. non-provisional patent application Ser. No. 13/891,399, filed May 10, 2013, entitled “Receivers for Wireless Power Transmission”.

### FIELD OF INVENTION

The present disclosure relates in general to receivers for wireless power transmission and more specifically to wireless power transmission receivers embedded in clothing and smart fabrics.

### BACKGROUND OF THE INVENTION

Warming and cooling circuits embedded in clothing pieces may require power for performing their intended functions. Often, these devices include battery packs that last typically from a few hours to a couple of days. The constant use of these devices may require periodical charging. In some cases, such an activity may be tedious and may represent a burden to users. For example, a user may he required to carry chargers or additional batteries and may have to remember to plug in the device or the batteries for a suitable amount of time. In addition, users have to find available power sources to connect to. In many occasions, such an activity may render the clothing inoperable during charging. For the foregoing reasons, there is a need for wireless power transmission systems capable of powering warming and cooling clothing without requiring extra chargers or plugs, without compromising the mobility and portability of the devices.

### SUMMARY OF THE INVENTION

The present disclosure provides various receiver arrangements which can be utilized for wireless power transmission using suitable techniques such as pocket-forming. The receivers may be embedded, using suitable techniques, in clothing pieces that include circuitry and may require electric current.

An apparatus for wireless power transmission to a temperature regulation circuit embedded in clothing or smart fabric, comprising: a pocket-forming transmitter having antenna elements, a RF circuit, a digital signal processor for controlling the RF circuit of the transmitter and communication circuitry connected to a power source; power RF waves generated from the RF circuit in the transmitter to form pockets of energy; a receiver embedded in the clothing or smart fabrics with communication circuitry and flexible antenna elements arranged in an array for capturing the pockets of energy converging in 3-D space at the receiver; a battery connected to the receiver for charging; and a heating circuit or a cooling circuit connected to the temperature regulation circuit embedded in the clothing or smart fabric connected to the receiver or the battery for powering the heating or cooling circuits.

In one embodiment, a receiver including at least one antenna element may be provided, where the antenna or antennas elements may be electrically coupled to at least one rectifier.

In some embodiments, the receivers may include one or more energy storage devices, such as lithium ion batteries rechargeable batteries.

In other embodiments, the energy storage devices may be attached to the clothing, and not embedded within the receiver.

In some embodiments, the receivers and batteries may be coupled to warming circuits, included in clothing pieces such as heating gloves, socks, underwear, shirts, jackets, and blankets, amongst others.

In some embodiments, the receivers and batteries may be included in clothing pieces carrying displays or other light emitting devices.

In other embodiments, the receivers and batteries may be included in clothing pieces that include cooling systems.

The systems and methods described in the present disclosure may allow wireless charging of multiple clothing pieces, which may enhance the user experience.

Numerous other aspects, features and benefits of the present disclosure may be made apparent from the following detailed description taken together with the drawing figures.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1 illustrates wireless power transmission using pocket-forming, according to an embodiment.

FIG. 2 illustrates a component level for a transmitter, according to an embodiment.

FIG. 3 illustrates a component level for a receiver, according to an embodiment.

FIG. 4 shows a heating blanket, according to an embodiment.

FIG. 5 illustrates a heating sock, according to an embodiment.

FIG. 6 illustrates a heating glove, according to an embodiment.

FIG. 7 illustrates a warming jacket, according to an embodiment.

FIG. 8 shows a shirt, according to an embodiment.

FIG. 9 shows a cap, according to an embodiment.

FIG. 10 illustrates a cooling shirt, according to an embodiment.

### DESCRIPTION OF THE DRAWINGS

The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

Definitions

“Pocket-forming” may refer to generating two or more RF waves which converge in 3-d space, forming controlled constructive and destructive interference patterns.

“Pockets of energy” may refer to areas or regions of space where energy or power may accumulate in the form of constructive interference patterns of RF waves.

“Null-space” may refer to areas or regions of space where pockets of energy do not form because of destructive interference patterns of RF waves.

“Transmitter” may refer to a device, including a chip which may generate two or more RF signals, at least one RF signal being phase shifted and gain adjusted with respect to other RF signals, substantially all of which pass through one or more RF antenna such that focused RF signals are directed to a target.

“Receiver” may refer to a device which may include at least one antenna, at least one rectifying circuit and at least one power converter for powering or charging an electronic device using RF waves.

“Adaptive pocket-forming” may refer to dynamically adjusting pocket-forming to regulate power on one or more targeted receivers.

### DETAILED DESCRIPTION OF THE DRAWINGS

The present disclosure describes systems and methods for charging clothing and smart fabrics using wireless power transmission.

In the following detailed description, reference is made to the accompanying drawings, which form a part hereof. In the drawings, which may not be to scale or to proportion, similar symbols typically identify similar components, unless context dictates otherwise. The illustrative embodiments described in the detailed description, drawings and claims, are not meant to be limiting. Other embodiments may be used and/or and other changes may be made without departing from the spirit or scope of the present disclosure.

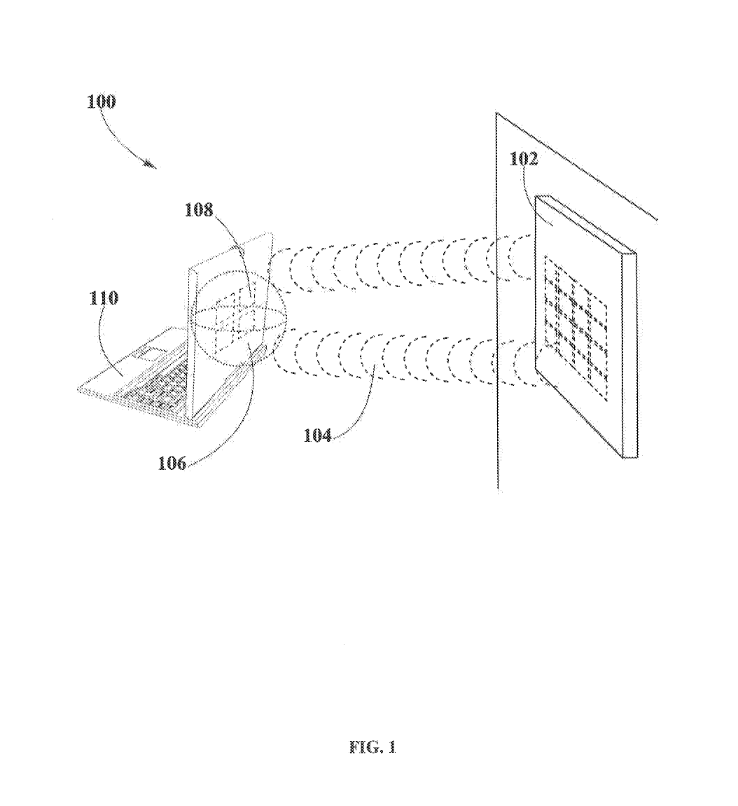

FIG. 1 illustrates wireless power transmission 100 using pocket-forming. A transmitter 102 may transmit controlled Radio Frequency (RF) waves 104 which may converge in 3-d space. These RF waves may be controlled through phase and/or relative amplitude adjustments to form constructive and destructive interference patterns (pocket-forming). Pockets of energy 106 may form at constructive interference patterns and can be 3-dimensional in shape whereas null-spaces may be generated at destructive interference patterns. A receiver 108 may then utilize pockets of energy 106 produced by pocket-forming for charging or powering an electronic device, for example a laptop computer 110 and thus effectively providing wireless power transmission 100. In some embodiments, there can be multiple transmitters 102 and/or multiple receivers 108 for powering various electronic devices, for example smartphones, tablets, music players, toys and others at the same time. In other embodiments, adaptive pocket-forming may be used to regulate power on electronic devices.

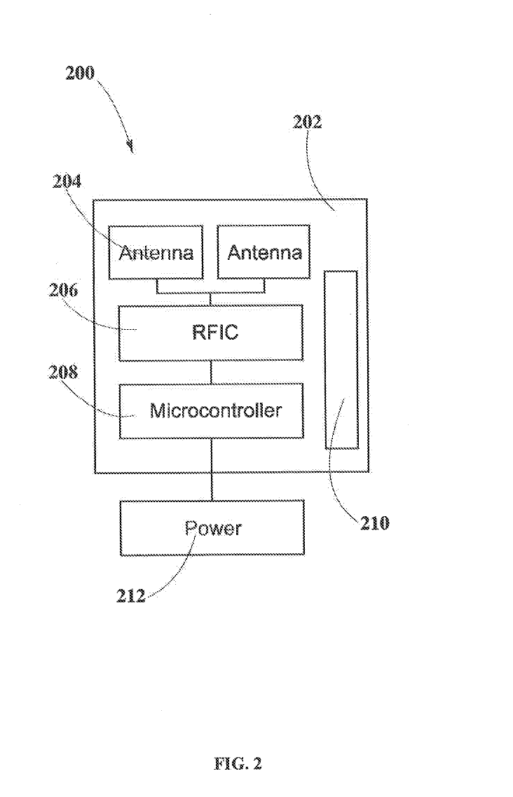

FIG. 2 illustrates a component level embodiment for a transmitter 200 which may be utilized to provide power transmission as in wireless power transmission 100. Transmitter 200 may include a housing 202 where at least two or more antenna elements 204, at least one RFIC 206 (RF integrated circuit), at least one digital signal processor (DSP) or micro-controller 208, and one communications component 210 may be included. Housing 202 can be made of any suitable material which may allow for signal or wave transmission and/or reception, for example plastic or hard rubber. Antenna elements 204 may include suitable antenna types for operating in frequency bands such as 900 MHz, 2.4 GHz or 5.8 GHz as these frequency bands conform to Federal Communications Commission (FCC) regulations part 18 (Industrial, Scientific and Medical equipment). Antenna elements 204 may include vertical or horizontal polarization, right hand or left hand polarization, elliptical polarization, or other suitable polarizations as well as suitable polarization combinations. Suitable antenna types may include, for example, patch antennas with heights from about 1/24 inches to about 1 inch and widths from about 1/24 inches to about 1 inch. Other antenna elements 204 types can be used, for example meta-materials, dipole antennas among others. RFIC 206 may include a proprietary chip for adjusting phases and/or relative magnitudes of RF signals which may serve as inputs for antenna elements 204 for controlling pocket-forming. These RF signals may be produced using an external power supply 212 and a local oscillator chip (not shown) using a suitable piezoelectric material. Micro-controller 208 may then process information send by a receiver 108 through communications component 210 for determining optimum times and locations for pocket-forming. Communications component 210 may be based on standard wireless communication protocols which may include Bluetooth, Wi-Fi or ZigBee. In addition, communications component 210 may be used to transfer other information such as an identifier for the device or user, battery 312 level, location or other such information. Other communications component 210 may be possible which may include radar, infrared cameras or sound devices for sonic triangulation for determining the device's position.

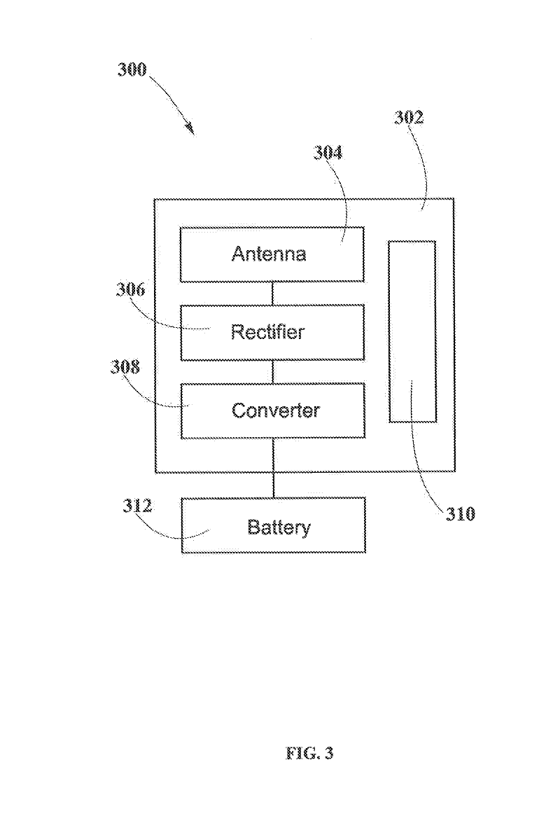

FIG. 3 illustrates a component level embodiment for a receiver 300 which can be used for powering or charging clothing pieces as exemplified in wireless power transmission 100. Receiver 300 may include a housing 302 where at least one antenna element 304, one rectifier 306, one power converter 308 and a communications component 310 may be included. Housing 302 can be made of any suitable material which may allow for signal or wave transmission and/or reception, for example plastic or rubber. In some embodiments, housing 302 may provide isolation of the circuit to protect it from external factors, such as water and sweat. Antenna element 304 may include suitable antenna types for operating in frequency bands similar to the bands described for transmitter 200 from FIG. 2. Antenna element 304 may include vertical or horizontal polarization, right hand or left hand polarization, elliptical polarization, or other suitable polarizations as well as suitable polarization combinations. Using multiple polarizations can be beneficial in devices where there may not be a preferred orientation during usage or whose orientation may vary continuously through time, for example a warming shirt or warming socks. Suitable antenna types may include patch antennas with heights from about 1/24 inches to about 1 inch and widths from about 1/24 inches to about 1 inch. Patch antennas may have the advantage that polarization may depend on connectivity, i.e. depending on which side the patch is fed, the polarization may change. This may further prove advantageous as a receiver 300, such as receiver 300, may dynamically modify its antenna polarization to optimize wireless power transmission 100. Rectifier 306 may include diodes or resistors, inductors or capacitors to rectify the alternating current (AC) voltage generated by antenna element 304 to direct current (DC) voltage, Rectifier 306 may be placed as close as is technically possible to antenna element 304 to minimize losses. After rectifying AC voltage, DC voltage may be regulated using power converter 308. Power converter 308 can be a DC-DC converter which may help provide a constant voltage output, regardless of input, to an electronic device, or as in this embodiment to a battery 312. Typical voltage outputs can be from about 5 volts to about 12 volts. In some embodiments, power converter 308 may include electronic switched mode DC-DC converters which can provide high efficiency. In such a case, a capacitor (not shown) may be included before power converter 308 to ensure sufficient current is provided for the switching device to operate. When charging an electronic device, for example a warming shirt or heating blanket, initial high currents which can break-down the operation of an electronic switched mode DC-DC converter may be required. In such a case, a capacitor (not shown) may he added at the output of receiver 300 to provide the extra energy required. Afterwards, lower power can be provided, for example 1/80 of the total initial power while having the clothing still build-up charge. Lastly, a communications component 310, similar to that of transmitter 200 from FIG. 2, may be included in receiver 300 to communicate with a transmitter 200 or to other electronic equipment.

In some embodiments, flexible, thin wiring, distributed in specific patterns, may be used as antennas. Different antenna, rectifier 306 or power converter 308 arrangements are possible for a receiver 300 as will be evident to one skilled in the art.

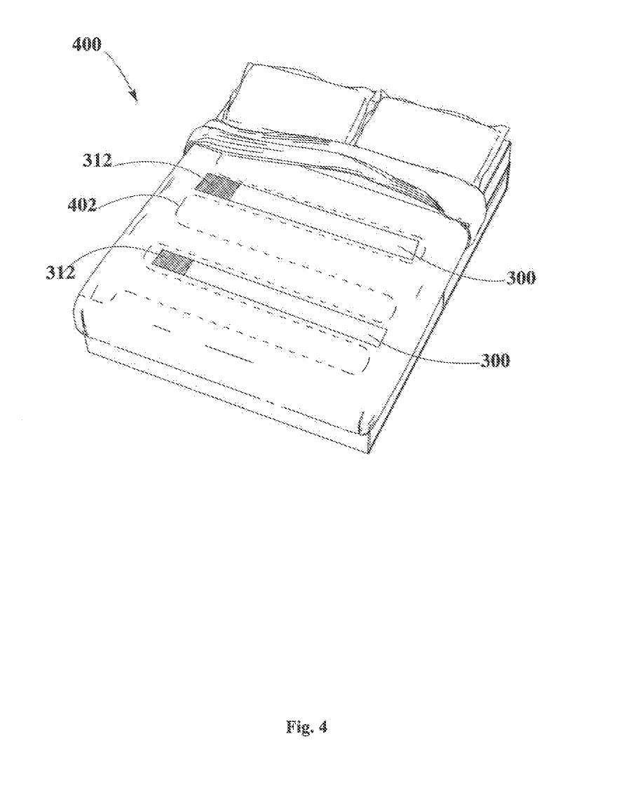

FIG. 4 shows a heating blanket 400, according to and embodiment. Heating blanket 400 may include a heating circuit 402, receivers 300 and flexible batteries 312.

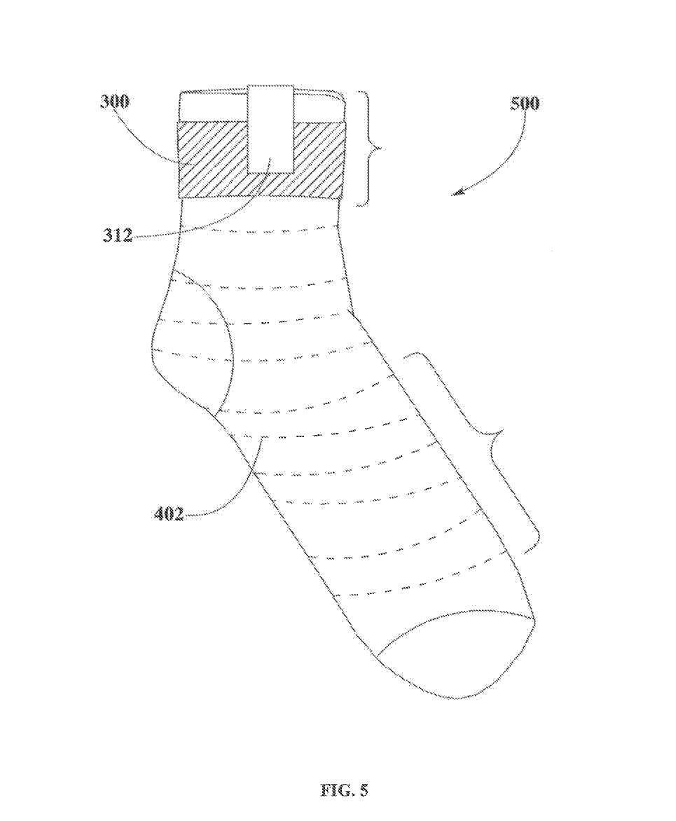

FIG. 5 illustrates a heating sock 500, according to an embodiment. Heating sock 500 may include a heating circuit 402, a receiver 300 and flexible rechargeable batteries 312.

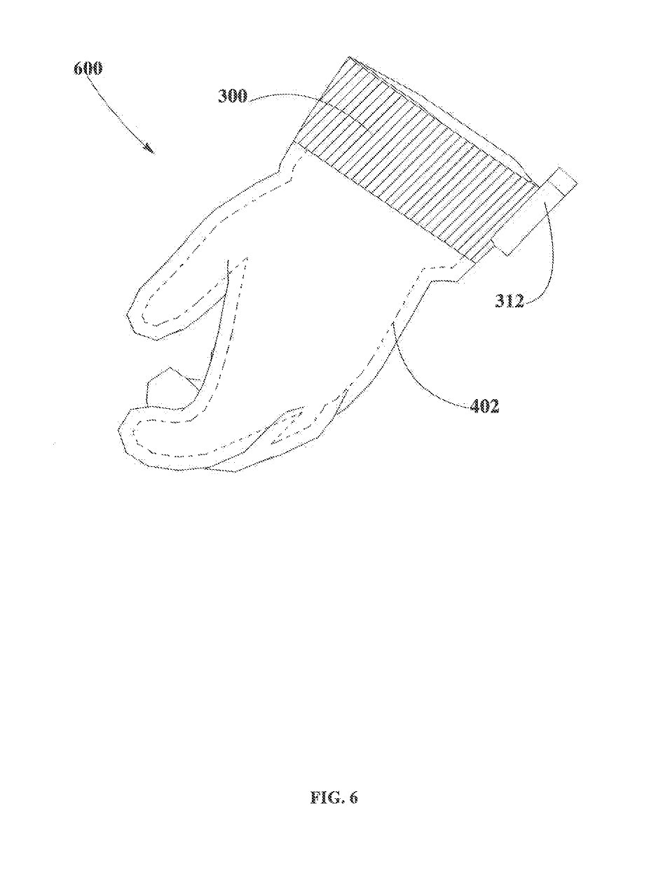

FIG. 6 shows a heating glove 600, according to an embodiment. Heating glove 600 may include a heating circuit 402, a receiver 300 and batteries 312.

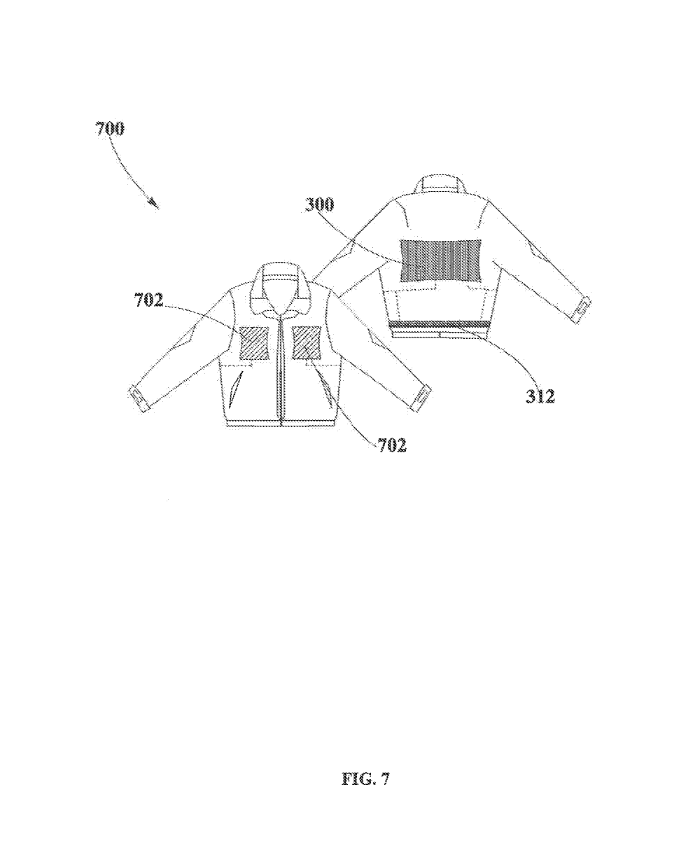

FIG. 7 illustrates a heating jacket 700, according to an embodiment. Heating jacket 700 may include heating patches 702, a receiver 300 and flexible batteries 312.

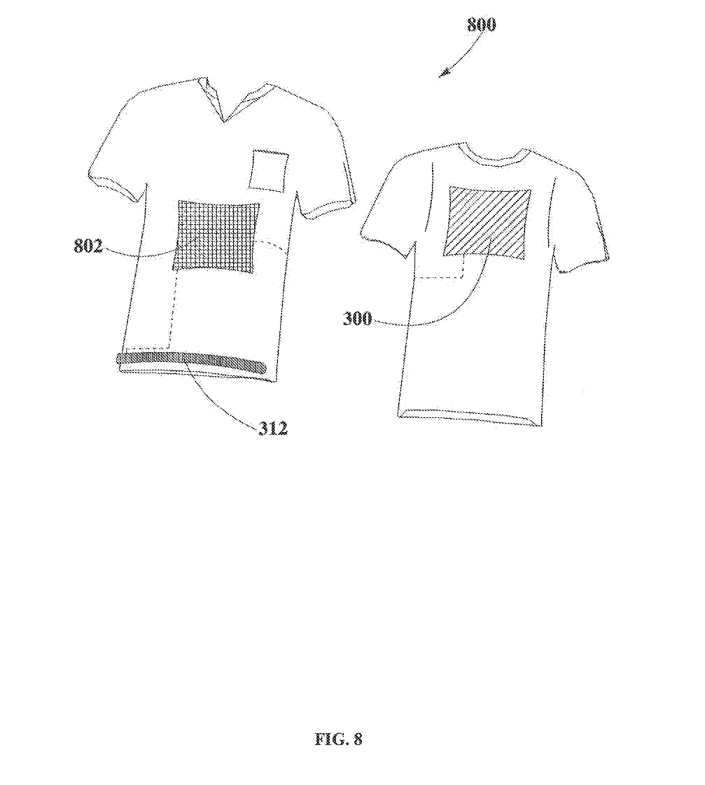

FIG. 8 shows a shirt 800, according to an embodiment. Shirt 800 may include a display 802 a receiver 300 and flexible batteries 312.

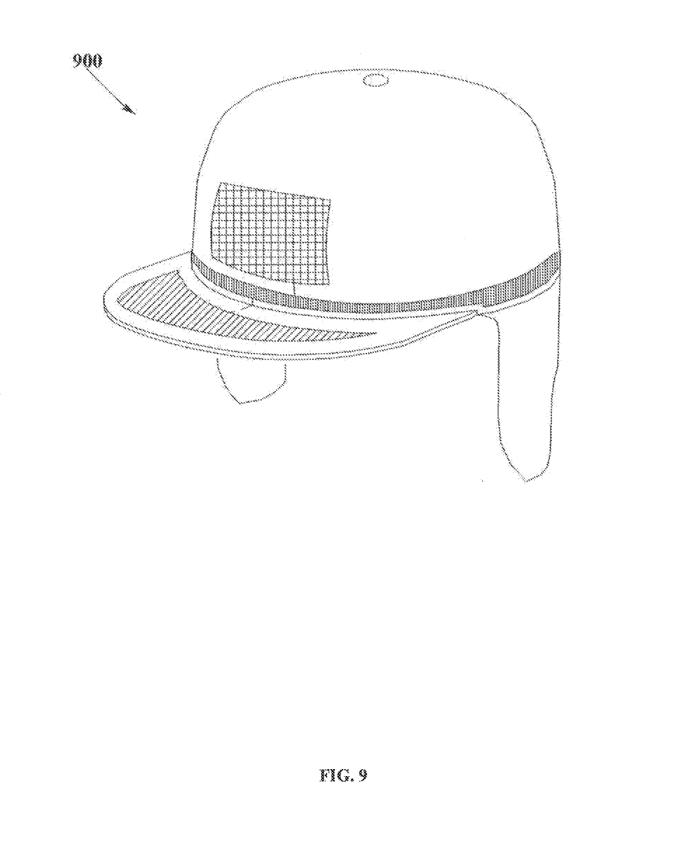

FIG. 9 illustrates a cap 900, according to an embodiment. Cap 900 may include a display 802 a receiver 300 and flexible batteries 312.

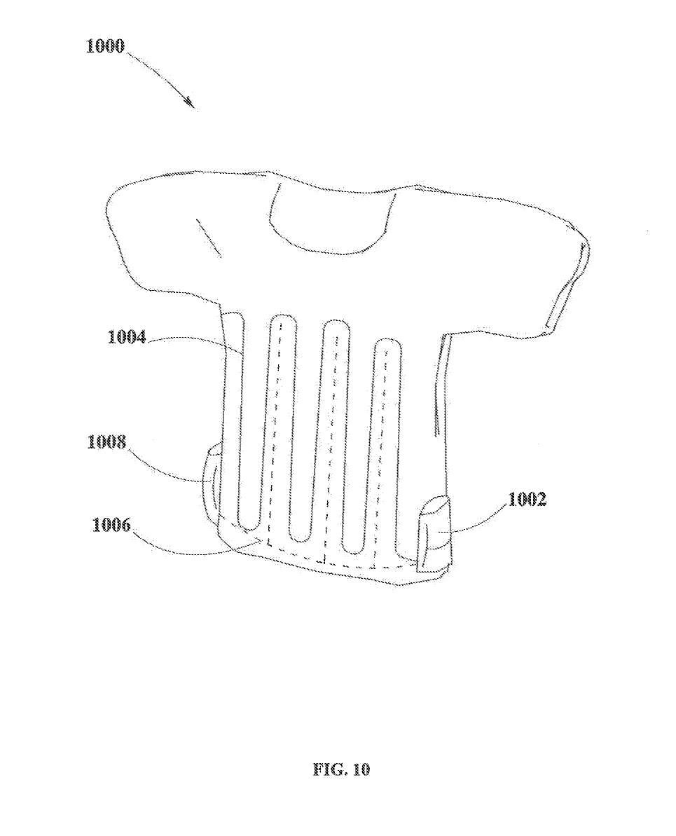

FIG. 10 shows a cooling shirt 1000, according to an embodiment. Cooling shirt 1000 may include a cooling liquid reservoir 1002, cooling tubes 1004, antenna wiring 1006 and case 1008. In some embodiments, case 1008 may include a battery 312, a receiver 300 and a pump for controlling the flow of cooling liquid through cooling tubes 1004.

### EXAMPLES

In example #1 a portable electronic heating jacket 700 that may operate at 7.4V may be powered or charged. In this example, a transmitter 200 may be used to deliver pockets of energy 106 onto heating jacket 700, in a process similar to the one depicted in FIG. 1. Transmitter 200 may have a single array of 8×8 of flat panel antennas where all the antenna elements 204 may operate in the same frequency band. Flat antennas may occupy less volume than other antennas, hence allowing a transmitter 200 to be located at small and thin spaces, such as, walls, mirrors, doors, ceilings and the like. In addition, flat panel antennas may be optimized for operating to long distances into narrow hall of wireless power transmission, such feature may allow operation of portable devices in long areas such as, train stations, bus stations, airports and the like. Furthermore, flat panel antennas of 8×8 may generate smaller pockets of energy 106 than other antennas since its smaller volume, this may reduce losses and may allow more accurate generation of pockets of energy 106. In this way, heating jacket 700 may be charged without being plugged and even during use. Heating jacket 700 may include a receiver 300 coupled to antenna elements 304; the optimal amount of antenna elements 304 that may be used with receivers 300 for heating jacket 700 may vary from about 10° F. to about 200° F., being most suitable about 50° F.; however, the amount of antennas within receivers 300 may vary according to the design and size of heating jacket 700. Antenna elements 304 may be made of different conductive materials such as cooper, gold, and silver, among others. Furthermore, antenna elements 304 may be printed, etched, or laminated onto any suitable non-conductive flexible substrate and embedded in heating jacket 700.

In example #2 a portable electronic heating socks 500, that may operate at 7.4V may be powered or charged. In this example, a transmitter 200 may be used to deliver pockets of energy 106 onto receivers 300 embedded on heating socks 500, following a process similar to the one depicted in FIG. 1.

While various aspects and embodiments have been disclosed, other aspects and embodiments are contemplated. The various aspects and embodiments disclosed are for purposes of illustration and are not intended to be limiting, with the true scope and spirit being indicated by the following claims.

Having thus described the invention, we claim:

1. A method for wireless power transmission to a temperature regulation circuit embedded in clothing or smart fabrics, comprising the steps of:
emitting power RF waves from a pocket-forming transmitter having a radio frequency integrated circuit, antenna elements, a microprocessor and communication circuitry;
generating pockets of energy from the transmitter to converge in 3-d space at predetermined locations within a predefined range;
integrating a receiver having antenna elements and communication circuitry within the clothing or smart fabric;
attaching the temperature regulation circuit to the receiver;
converting the pockets of energy in 3-d space from the transmitter to the receiver integrated with the clothing or smart fabric to power and to regulate the temperature within the temperature regulation circuit.

2. The method for wireless power transmission to the temperature regulation circuit embedded in clothing or smart fabrics of claim 1, wherein the temperature regulation circuit includes an electrical resistance to dissipate electrical energy as heat within the clothing or smart fabric.

3. The method for wireless power transmission to the temperature regulation circuit embedded in clothing or smart fabrics of claim 1, wherein the antenna elements are flexible, thin wiring that is distributed in predetermined patterns within the clothing or smart fabric,

4. The method for wireless power transmission to the temperature regulation circuit embedded in clothing or smart fabrics of claim 1, wherein the communication circuitry of the transmitter and receiver in conjunction with the microprocessor controls the temperature of the temperature regulation circuit in the clothing or smart fabric.

5. The method for wireless power transmission to the temperature regulation circuit embedded in clothing or smart fabrics of claim 1, wherein the temperature regulation circuit within the receiver includes a heating or cooling circuit within the clothing or smart fabric connected to a flexible battery or the receiver for power.

6. The method for wireless power transmission to a temperature regulation circuit embedded in clothing or smart fabrics of claim 1, further including the step of distributing the antenna elements of the receiver in a predetermined pattern on the clothing or smart fabric.

7. The method for wireless power transmission to a temperature regulation circuit embedded in clothing or smart fabrics of claim 2, further including the step of adding a capacitor to an output circuit of the receiver to increase the charging energy for the electrical resistance in the heating of the clothing or smart fabric.

8. The method for wireless power transmission to a temperature regulation circuit embedded in clothing or smart fabrics of claim 1, wherein the receiver antenna elements and flexible battery for powering the temperature regulation circuit are mounted on the surface of the clothing or smart fabric with the antenna elements in a predetermined array for capturing the pockets of energy.

9. The method for wireless power transmission to a temperature regulation circuit embedded in clothing or smart fabrics of claim 1, wherein the clothing is a sock having resistance heating circuit woven throughout the sock connected to the receiver surrounding a neck of the sock with a flexible, rechargeable battery connected to the receiver for charging the battery and to the resistance heating circuit to warm the sock.

10. The method for wireless power transmission to a temperature regulation circuit embedded in clothing or smart fabrics of claim 1, wherein the clothing is a glove having a resistance heating circuit woven into glove fingers connected to a battery for power wherein the battery is connected to the receiver with flexible antenna elements mounted approximately at the opening of the glove.

11. The method for wireless power transmission to a temperature regulation circuit embedded in clothing or smart fabrics of claim 1, wherein the clothing is a heating jacket having flexible heating patches with resistance elements connected to a flexible receiver for receiving the pockets of energy to power the heating patches and a battery mounted on the heating jacket for storing energy from the receiver to provide power to resistance elements.

12. The method for wireless power transmission to a temperature regulation circuit embedded in clothing or smart fabrics of claim 1, wherein the clothing is a shirt having a flexible display panel thereon or a flexible heating patch thereon connected to a battery for power and the receiver connected to the battery for charging the battery or for operating the display panel or heating patch.

13. The method for wireless power transmission to a temperature regulation circuit embedded in clothing or smart fabrics of claim 1, wherein the clothing is a cap having an electronic display connected to a flexible battery mounted on a circumference of the cap and wherein the receiver is connected to the display and to the battery for operating and charging, respectively,

14. The method for wireless power transmission to a temperature regulation circuit embedded in clothing or smart fabrics of claim 1, wherein the clothing is a cooling shirt including a cooling reservoir connected to cooling tubes distributed across the shirt and a case having the receiver and a battery connected to a pump for powering and controlling the flow of a cooling liquid through the cooling tubes.

15. The method for wireless power transmission to a temperature regulation circuit embedded in clothing or smart fabrics of claim 1, wherein the antenna elements of the transmitter and receiver operate in frequency bands of 900 MHz, 2.4 GHz, 5.8 GHz or other approved law enforcement frequency bands.

16. The method for wireless power transmission to a temperature regulation circuit embedded in clothing or smart fabrics of claim 1., wherein the communication circuitry between the transmitter and receiver allows the control of the temperature regulation circuit within the clothing and smart fabric through the microprocessor to avoid extremes in heat or cooling within the clothing and smart fabric.

17. The method for wireless power transmission to a temperature regulation circuit embedded in clothing or smart fabrics of claim 1, wherein the receiver antenna elements are arranged in a flat panel 8×8 array made of conductive materials including copper, gold, silver among others wherein the antenna elements are printed, etched or laminated onto any suitable non-conductive flexible substrate and embedded in the clothing or smart fabric.

18. An apparatus for wireless power transmission to a temperature regulation circuit embedded in clothing or smart fabric, comprising:
a pocket-forming transmitter having antenna elements, a RF circuit, a digital signal processor for controlling the RF circuit of the transmitter and communication circuitry connected to a power source;
power RF waves generated from the RF circuit in the transmitter to form pockets of energy;
a receiver embedded in the clothing or smart fabrics with communication circuitry and flexible antenna elements arranged in an array for capturing the pockets of energy converging in 3-D space at the receiver;
a battery connected to the receiver for charging the battery; and
a heating circuit or a cooling circuit connected to the temperature regulation circuit embedded in the clothing or smart fabric connected to the receiver or to the battery for powering the heating or cooling circuits.

19. An apparatus for wireless power transmission to a temperature regulation circuit embedded in clothing or smart fabric of claim 18, wherein the transmitter and receiver communication circuitry utilizes Bluetooth, infrared, WiFi, FM radio or Zigbee signals for the various communication protocol is between the receiver and the transmitter to regulate the heating or cooling of the clothing and smart fabric by the microprocessor.

20. An apparatus for wireless power transmission to a temperature regulation circuit embedded in clothing or smart fabric of claim 18, wherein the receiver, receiver antenna elements, receiver communication circuitry and battery are all made out of a single flexible substrate or individual interconnected substrates mounted or embedded within the clothing or smart fabric.
